(19) United States
(12) Patent Application Publication
(10) Pub. No.: US 2026/0229246 A1
(43) Pub. Date: Aug. 6, 2026

(54) CONTEXTUAL DYNAMIC SELECTION OF MACHINE LEARNING MODELS FOR OPTIMIZATION OF AUDIO PROCESSING INSIDE ENVIRONMENTS

(71) Applicant: QSC, LLC, Costa Mesa, CA (US)

(72) Inventor: Jainish Nileshkumar Chauhan, San Diego, CA (US)

(21) Appl. No.: 19/468,251

(22) Filed: Feb. 3, 2026

Related U.S. Application Data
(60) Provisional application No. 63/753,363, filed on Feb. 3, 2025.

(51) Int. Cl. G10L 25/51; G06N 20/00; G10L 15/20; G10L 21/0216; G10L 25/30; G10L 15/22

(52) U.S. Cl. CPC G10L 25/51; G06N 20/00; G10L 15/20; G10L 21/0216; G10L 25/30; G10L 2015/223

(57) ABSTRACT

Described herein are systems to monitor the context of an environment in real-time and select an appropriate machine learning model from a remote location (e.g., cloud platform) to be deployed on an audio, video and control (“AVC”) system inside the environment. The contextual data provides the system with situational awareness of the environment. The AVC system includes one or more core processors and peripheral equipment. Through deployment of the machine learning models, the operating system being executed by the AVC system performs all of audio, video, and control processing on the processing core.

### PRIORITY

The present application is a non-provisional of and claims priority to U.S. Provisional Application No. 63/753,363, entitled “CONTEXTUAL DYNAMIC SELECTION OF MACHINE LEARNING MODELS FOR OPTIMIZATION OF AUDIO PROCESSING INSIDE ROOM ENVIRONMENTS, having the same inventorship, filed on February 3^{rd}, 2025, the disclosure of which is hereby incorporated by reference in its entirety.

### FIELD OF THE INVENTION

The present invention relates generally, but not limited to, audio processing optimization and, more specifically, to methods and systems using contextual data to select machine learning models from a remote location for deployment inside a local room environment to achieve optimization of audio processing.

### BACKGROUND

In the area of room audio optimization, there are a wide range of artificial intelligence machine learning models available for use. Such models differ in terms of model size/latency, performance, and use case. Typically, the larger models are more general purpose, i.e., once they are developed the models can be deployed in any room and can tackle any scenario. However, at the same time, generally they are more latent and memory consuming. There are smaller models which are less latent and memory consuming, but they are not general purpose, i.e., they typically work well only for specific scenario or a room. Thus, every time there is a new room or scenario the model needs to be replaced. Alternatively, multiple smaller models may be deployed in sequence to tackle different scenarios, which ultimately leads to higher latency and memory consumption.

### BRIEF DESCRIPTION OF THE DRAWINGS

FIG. 1 is a block diagram illustrating an overview of a processing core, according to certain illustrative embodiments of the present disclosure.

FIG. 2 illustrates a room environment in which the processing core of FIG. 1 may be utilized, according to illustrative embodiments of the present disclosure.

FIGS. 3A and 3B are block diagrams showing a processing flow for a noise suppression model, according to certain illustrative embodiments of the present disclosure.

FIG. 3C is a flow chart of a method for training the machine learning models, according to an illustrative embodiment of the present disclosure.

FIGS. 4A and 4B are block diagrams showing a processing flow in the case of multiple overlapping noise sources, according to certain illustrative embodiments of the present disclosure.

FIGS. 5A and 5B are block diagrams showing a processing flow in the case of speech separation, according to certain illustrative embodiments of the present disclosure.

FIG. 6 is a flow chart of a computer-implemented method 600 of the present disclosure.

FIG. 7 is a flow chart of a computer-implemented method 700 of the present disclosure.

### DESCRIPTION OF ILLUSTRATIVE EMBODIMENTS

Illustrative embodiments and related methods of the present disclosure are described below as they might be employed to select machine learning models to deploy inside environments based upon contextual data of the room. In the interest of clarity, not all features of an actual implementation or methodology are described in this specification. It will of course be appreciated that in the development of any such actual embodiment, numerous implementation-specific decisions must be made to achieve the developers’ specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methodologies of the disclosure will become apparent from consideration of the following description and drawings.

As used herein, the term "environment" refers broadly to any space or area in which audio and/or video data may be captured and in which the systems and methods of the present disclosure may be deployed. While certain embodiments are described with reference to a room environment, such as a conference room, huddle space, boardroom, auditorium, or other indoor space, the present disclosure is not so limited. The environment may comprise any indoor space, including but not limited to offices, classrooms, lecture halls, studios, theaters, places of worship, healthcare facilities, retail spaces, manufacturing floors, and residential spaces. The environment may also comprise outdoor spaces, including but not limited to amphitheaters, stadiums, outdoor event venues, construction sites, parks, courtyards, patios, and other open-air locations. The environment may further comprise transitional or enclosed mobile spaces, such as vehicles (e.g., automobiles, buses, trains, aircraft, watercraft), tents, temporary structures, and portable enclosures. In each case, the microphones, cameras, and other sensors described herein may be positioned within or proximate to the environment to capture audio and/or video data, and the machine learning models selected and deployed by the system may be tailored to the acoustic and visual characteristics of that particular environment. Accordingly, references to a "room environment" or "room" throughout this disclosure should be understood to encompass any such environment unless the context clearly indicates otherwise.

There are a wide range of machine learning models available for use inside room environments. Such models differ in terms of model size/latency, performance and use case. Typically, as mentioned above, the larger the model, the more latency is introduced. And on the other hand, smaller models are faster but they are more task specific, thus every time the room environment changes (e.g., different number of room occupants, different noises, etc.) the models deployed to the room environment must be manually changed. Alternatively, multiple smaller models may be deployed to the room environment that ultimately leads to high latency and memory consumption.

Accordingly, illustrative embodiments of the present disclosure provide methods and systems to monitor the context of a room environment in real-time and dynamically select and deploy an appropriate machine learning model to a computing system such as, for example, an audio, video and control (“AVC”) system inside the room environment. The contextual data provides the system with situational awareness of the room environment and may take a variety of forms such as, for example, video, audio, textual or geo-spatial data, third-party application (e.g., calendaring application, weather application, etc.) as well as data related to the status of one or more peripherals of the system, such as an HVAC system. In certain embodiments, for example, the system uses only third party contextual data (e.g., social media data, textual data, geo-position data, weather application data, calendar data) and does not use any audio or video data in the model selection process. Nevertheless, as described herein, an audiovisual system includes one or more core processors and peripheral equipment such as, for example, speakers, touchscreen controllers, microphones, cameras, bridging devices, network switch, HVAC equipment and so on.

An AVC system is a system configured to manage and control functionality of audio features, video features, and control features. For example, an AVC system of the present disclosure can be configured for use with networked microphones, cameras, amplifiers, controllers, and so on. The AVC system can also include a plurality of related features, such as acoustic echo cancellation, multi-media player and streamer functionality, user control interfaces, scheduling, third-party control, voice-over-IP (“VoIP”) and Session Initiated Protocol (“SIP”) functionality, scripting platform functionality, audio and video bridging, public address functionality, other audio and/or video output functionality, etc. One example of an AVC system is included in the Q-SYS® technology from QSC, LLC, the assignee of the present disclosure.

In a generalized method of the present disclosure, the processing core captures audio and/or video data using a microphone or camera positioned within the room environment. The audio and/or video data is then processed in order to generate contextual data regarding the room environment. The contextual data provides the system with situational awareness of the room environment and may take a variety of forms such as, for example, video, audio, textual or geo-spatial data, third-party application data, as well as data related to the status of one or more peripherals on the system. Here, for example, the contextual data may refer to the size of the room environment, number of active talkers in the room, the noise sources in the room, materials used to build the walls of the room, calendar-related data, weather data, etc. The system then analyzes the contextual data to select one or more machine learning models stored in the remote location such as, for example, a cloud platform. The selected machine learning model is then downloaded from the remote location and onto the AVC system, where the model is applied to optimize the processing of the audio signals within the room environment.

As briefly mentioned above, in the context of audio artificial intelligence (“AI”), there are a wide range of machine learning models in terms of model size/latency, performance and use case. On one end of the spectrum, there are large, general-purpose, high-performance models, with high latency. On the other hand, there are small models with lower latency, but lower performance as well. In between those two extremes, there are models which are small, less latent, and task specific, i.e. those models perform really well for a targeted task, but they start to fail as the task moves out of the target domain. For example, there are deep noise suppression models which work really well if they are exposed to noise sources from only a couple classes. Perhaps the NS-M1 (Noise suppression-Model 1) model works well when used to remove the pen click and mouse click noises and not for other classes. There is also the NS-M2 model, which works well for the munching and keyboard typing noise and not otherwise. Further, there is the NS-M3 model which works well with crumpling-crinkling and paper rumbling noise, but not otherwise.

In another example, assume a total of ten such machine learning models which can handle twenty different noise types. These models are small and have very low latency individually; however, they are not deployable directly in the meeting rooms because of the following reasons: First, if just one of the models is deployed, it won’t remove the other noises in the room. As a result, the overall experience won’t be good because generally there are all sorts of noises in the meeting rooms. Second, deployment of multiple models will consume a lot of memory. The combined latency will also be higher because each of the models will process the audio sequentially to makes sure that all of the noises are removed. In this case, it would turn out to be more or less the same as using the large general-purpose model.

Another similar use case is for speech separation applications. Generally, in speech separation models, the number of separated output talkers is fixed. The performance of the model can be poor if the input audio has more talkers versus the number of output ports. One easy fix for this is to have a model which has a very large number of output ports compared to the number of talkers generally seen in the meeting room – i.e., six output ports to account for six different overlapping talkers which is really rare in real-life scenarios. However, this solution is not robust because it might fail if, by chance, a scenario occurs where there are more than six talkers.

Moreover, generally a model which can handle six output ports is pretty large in size and has high latency. It becomes even more redundant if the large model is deployed everywhere regardless of the context of room. It makes no sense to deploy a model with six outputs in a small room which can only have four talkers in it at a time. Even though all output ports are not being fully utilized, the computing resources are still being wasted through use of the six outputs that come with high latency. Instead, a smaller model with just three output ports could be deployed in the smaller room (where use of a large model with a higher number of outputs would not make sense). On the other hand, a large room does not always necessitate use of a large model. Even though the room is large, the number of active overlapping talkers can still be low. In such cases, as discussed in the exemplary embodiments herein, the solution would be for the system to monitor the number of active talkers in the room and deploy the appropriately sized model based on the context of the room.

Similarly, there could be different machine learning models tuned for different reverberation characteristics of the room. Also, different models can be deployed based on different sitting arrangements in the room, etc. For example, a model could be deployed which works particularly well in a boardroom setting, where there is a presenter in front and two rows of audience: one at lower height and other at higher height, with the walls made of wood, and the overall room being less reverberant. There can be another model tailored to work well for a collaboration space where there is a table in the center and participants around it and where there is a glass wall which makes the room very reverberant.

As one can see, there can be a large number of machine learning models, but it can be impractical to deploy them all on premise. Further, selecting one of these models manually every time there is a new room environment is also impractical. One alternate solution is to have one large general-purpose model which works everywhere; however, those large models are very chunky, still consume lots of unnecessary resources, and have high latency.

Accordingly, illustrative embodiments of the present disclosure provide solutions to these problems by monitoring the context of the room environment in real time and dynamically selecting the appropriate models from a remote location (e.g., the cloud) or locally (e.g., AI accelerator, server on-site, processing core, etc.). Here, the context may, for example, refer to the size of the room, number of active talkers in the room, the noise sources in the room, materials used to build the walls of the room etc. The contextual data can be obtained through processing different modalities such as, for example, video signals/data from cameras and audio signals/data from microphones, as well as third party data (e.g., weather info, calendar info, and the like) and data from peripherals (e.g., HVAC systems, and the like), to determine the number of participants in the room environment, number of active talkers in the meeting, noise sources and types in the room, the size of the room, the seating arrangement in the room, the materials used in constructing the room, etc.

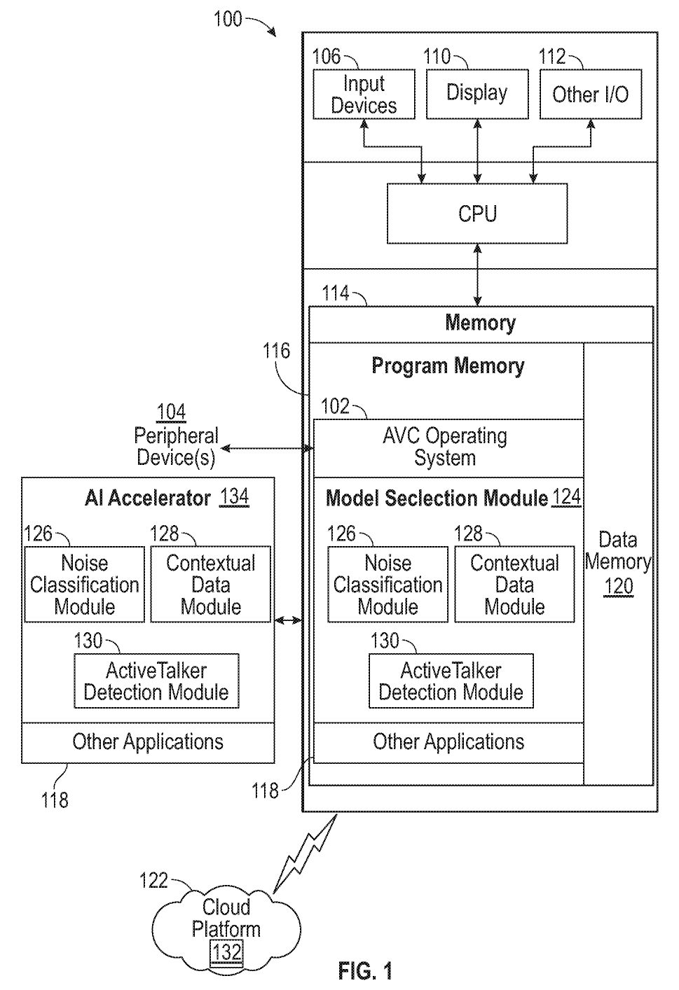

FIG. 1 is a block diagram illustrating an overview of a processing core, according to certain illustrative embodiments of the present disclosure. Note although referred to herein as an AVC processing core, processing core 100 could be any suitable type of processing core capable of processing any of audio, video, control or other analog/digital signals. Processing core 100 includes various hardware components, modules, etc., which comprise an AVC operating system (“OS”) 102 used to manage and control functionality of various audio, video, and control features of one or more peripheral devices 104 or other third-party applications/platforms (not shown) that may be running on peripheral devices 104 or one or more computing devices. Peripheral devices 104 may be any variety of devices such as, for example, cameras, microphones, touchscreen controllers, bridging devices, network switches, speakers, televisions, other audiovisual equipment, shades, HVAC units, and so on. The applications/platforms may include, for example, calendar platforms, weather-related platforms, remote conferencing platforms, etc.

Processing core 100 can include one or more input devices 106 that provide input to the CPU(s) (processor) 108, notifying it of actions. The actions can be mediated by a hardware controller that interprets the signals received from the input device and communicates the information to the CPU 108 using a communication protocol. Input devices 106 include, for example, a mouse, a keyboard, a touchscreen, an infrared sensor, a touchpad, a wearable input device, a camera- or image-based input device, a microphone, personal computer, smart device, or other user input devices.

CPU 108 can be a single processing unit or multiple processing units in a device or distributed across multiple devices. CPU 108 can be coupled to other hardware devices, for example, with the use of a bus, such as a PCI bus or SCSI bus. The CPU 108 can communicate with a hardware controller for devices, such as for a display 110. Display 110 can be used to display text and graphics. In some implementations, display 110 provides graphical and textual visual feedback to a user. In some implementations, display 110 includes the input device as part of the display, such as when the input device is a touchscreen or is equipped with an eye direction monitoring system. In some implementations, the display is separate from the input device. Examples of display devices are an LCD display screen, an LED display screen, a projected, holographic, or augmented reality display (such as a heads-up display device or a head-mounted device), and so on. Other I/O devices 112 can also be coupled to the processor, such as a network card, video card, audio card, USB, firewire or other external device, camera, printer, speakers, CD-ROM drive, DVD drive, disk drive, or Blu-Ray device.

In some implementations, processing core 100 also includes a communication device (not shown) capable of communicating wirelessly or wire-based with other systems on the network such as, for example, cloud platform 122. The communication device can communicate with another device or a server through a network using, for example, TCP/IP protocols, a Q-LAN protocol, or others. processing core 100 can utilize the communication device to distribute operations across multiple network devices.

The CPU 108 can have access to a memory 114 which may include one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 114 can include program memory 116 that stores programs and software, such as an AVC operating system 102 and other application programs 118. Memory 114 can also include data memory 120 that can include data to be operated on by applications, configuration data, settings, options or preferences, etc., which can be provided to the program memory 116 or any element of the processing core 100.

Some implementations can be operational with numerous other computing system environments or configurations. Examples of computing systems, environments, and/or configurations that may be suitable for use with the technology include, but are not limited to, personal computers, AV I/O systems, networked AV peripherals, video conference consoles, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

Memory 114 further includes a machine learning model selection module 124 used to perform the model selection operations as described herein. In one illustrative processing flow, processing core 100 accesses the audio feed from a room environment using one or more microphones (peripheral devices 104), along with the video feed from one or more cameras. The audio and video data/signals are then received by model selection module 124 where the contextual data is generated and processed (by contextual data module 128) to determine the source of the noise to thereby classify the audio signals (using noise classification module 126) into one or more (e.g., twenty) curated noise classes. In addition to the audio/video signals, other data may also be utilized by contextual data module 128 to determine the context of the room such as, for example, data from third party platforms (e.g., calendar or weather related data) and peripherals on the system (e.g., the status of HVAC equipment).

The identified noise class information is then transmitted to cloud platform 122, which includes processing circuitry to work in conjunction with processing core 100. In this example, ten different noise suppression models are housed in cloud platform 122, each of which can process two types of noise sources. Based upon the identified noise class, processing circuitry of cloud platform 122 selects the appropriate noise suppression model. Thereafter, processing core 100 downloads the selected noise suppression model from cloud platform 122 to be deployed on AVC operating system 102 or some other local processing device which is then used to optimize audio processing within the room environment.

Thereafter, processing core 100 continuously passes audio signals through noise classification module 126. In the event the identified noise class changes from the class that is handled by the deployed noise suppression module, the process flow described above is performed and another suitable noise suppression module is selected and downloaded from cloud platform 122.

In certain other embodiments, processing core 100 monitors the identified noise class continuously to determine how frequently it changes and between which noise categories. If, over the course of the meeting, processing core determines there are two particular noise types which are more frequent than others, the system then may download noise suppression models for those two categories and tie them together sequentially. Here, the audio signals will first get passed through the first deployed noise suppression model (e.g., NS-M1) which will remove most frequent noise type-1, and then pass that output of the first deployed model through a second deployed noise suppression model (e.g., NS-M2) which will then remove the most frequent noise type-2.

In certain examples, model selection module 124 can identify the noise classification based solely on the contextual data derived from the audio and video signals received from one or more microphones and cameras (peripheral devices 104) located inside the room environment. However, in other alternative embodiments, model selection module 124 can utilize other contextual data of the room environment in order to assist in classifying the audio signals. Here, for example, the contextual data may refer to the room size, number of active talkers in the room, noise sources in the room, materials used to build the walls of the room, etc. In addition to audio and video signals, the contextual data may be obtained through other modalities and systems such as, for example, textual data input by a user via input device 106, weather, calendar-related info or other system related data (e.g., state of HVAC equipment) received from other applications 118, etc.

Ultimately, the contextual data is obtained and processed by contextual data module 128 in order to assist model selection module 124 in determining what is happening inside the room, for example, the number of participants in the room (e.g., determined from receiving meeting information from a third-party calendar application), number of active talkers in the room, noise sources and types in the room (e.g., noise sources based on capturing audio via microphones in the room, receiving a thunderstorm alert from a third-party weather application, and the like), room size, seating arrangement in the room, materials used to construct the room, etc. To further assist in other illustrative embodiments, model selection module 124 utilizes an active talker detection module 130 to determine the number of talkers/participants in the room, along with their identity. Any variety of active talker identification techniques may be employed such as, for example, a computer vision model-based solution to detect lip movements to locate active talker(s).

In certain other illustrative embodiments, an AI accelerator 134 is communicably coupled to one or more processing cores 100 in order to assist in performing some or all the model selection operations described herein. Here, as can be seen, AI accelerator 134 may include the same modules as model selection module 124, namely noise classification module 126, contextual data module 128 and/or active talker detection module 130, as well as other applications 118. AI accelerator 134 may be located on processing core 100 or remote therefrom, as well as being in communication with cloud platform 122. AI accelerator 134 may comprise a specialized hardware component or system designed to increase the efficacy of computational processes required for artificial-intelligence tasks, particularly those relating to machine learning or deep-reinforcement learning. For example, AI accelerator 134 may comprise any of graphics processing units to ingest and process video data, tensor processing units for processing deep-learning tasks and large-scale neural network computations for processing audio data, field-programmable gate arrays, application-specific integrated circuits to accelerate neural network operations, and neural processing units dedicated to processing image and video data and natural language processing. Artificial intelligence tasks (such as neural networks and the like) require complex calculations that are computationally intensive. AI accelerator 134 may be able to manage these types of tasks more efficiently than core processor 100.

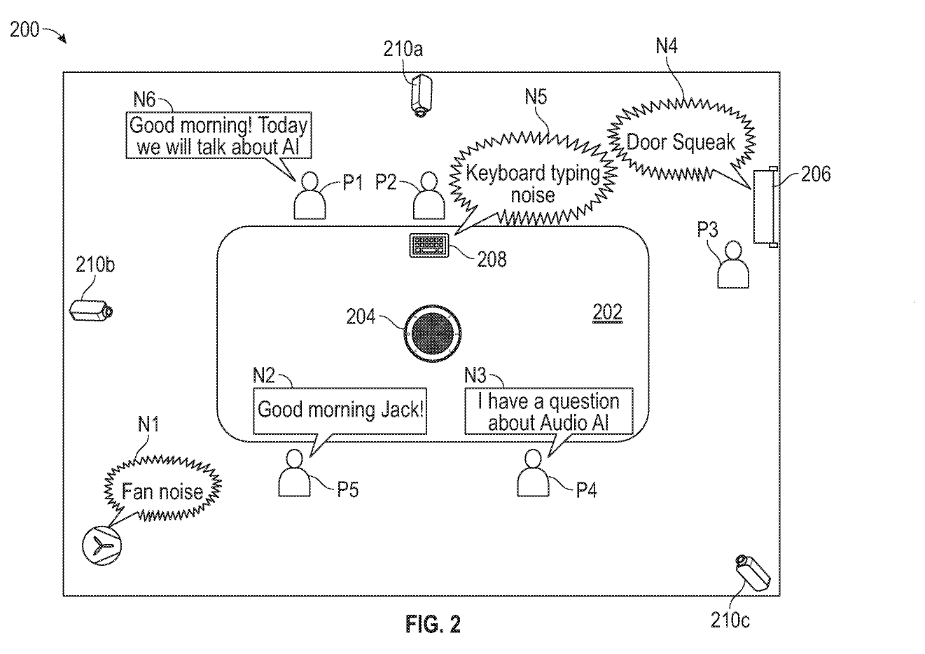

FIG. 2 illustrates a room environment in which processing core 100 may be utilized, according to illustrative embodiments of the present disclosure. For this example, room environment 200 is a meeting room in which five persons P1, P2, P3, P4 and P5 are located. P1, P2, P4 and P5 are positioned around a table 202. A microphone 204 is positioned atop table 202 in order to obtain audio signals within the room. In this example, a number of noise sources are present within room environment 200 including N1 (fan noise), N2 (speech from P5), N3 (speech from P4), N4 (squeaking noise from door 206), N5 (clicking noise from keyboard 208), and N6 (speech noise from P1). In addition, there are a plurality of cameras 210 a,b,c positioned around room 200 in order to obtain video signals used to provide contextual data to the system.

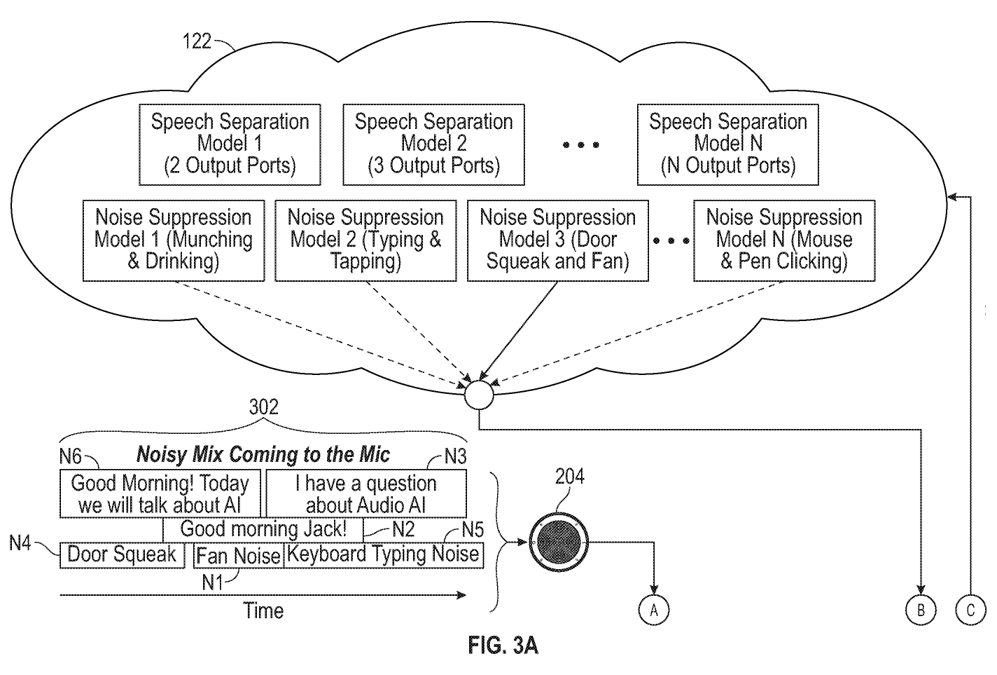

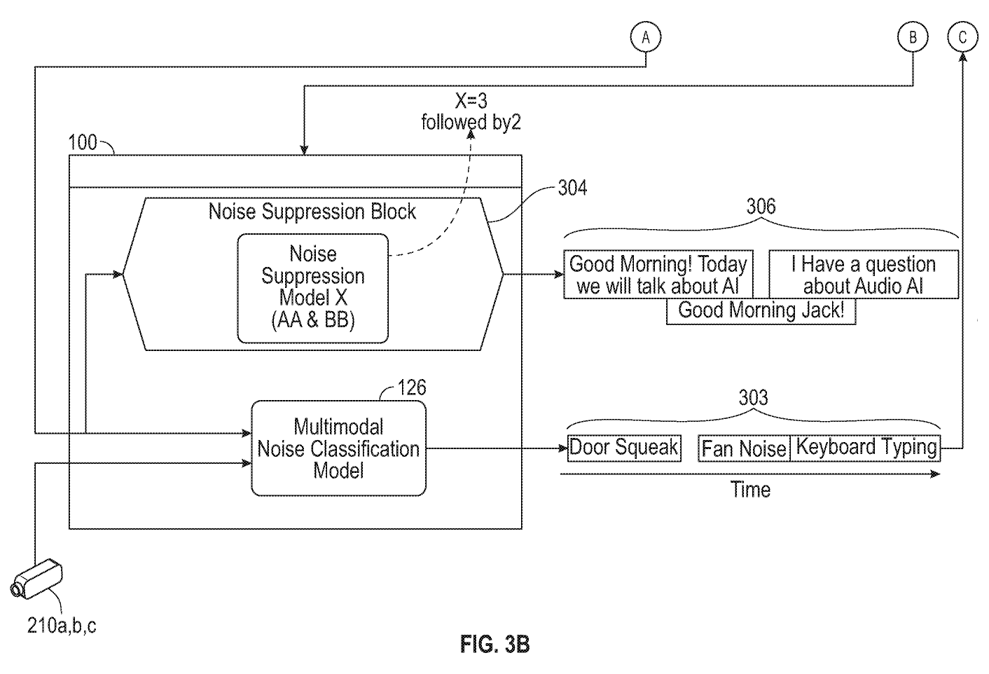

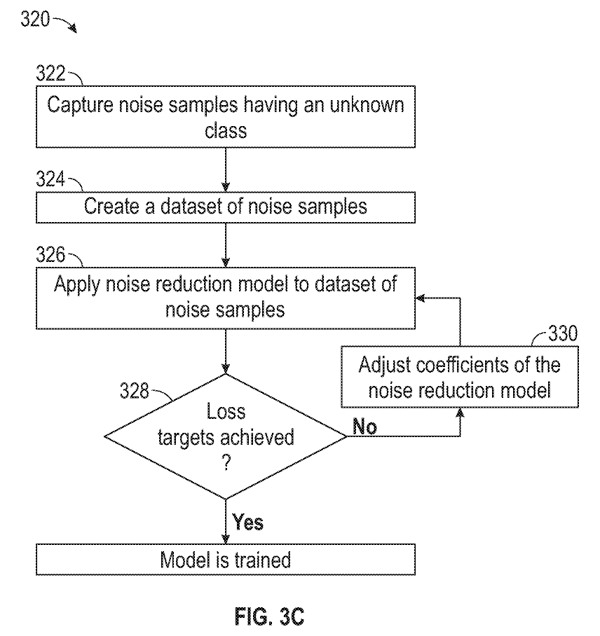

FIGS. 3A and 3B are block diagrams showing a processing flow for selection of a noise suppression model, according to certain illustrative embodiments of the present disclosure. Here, processing core 100 is being implemented inside room environment 200. Processing core 100 is shown along with microphone 204. A noisy mix of audio signals 302 is captured by microphone 204 including noise sources N1-N6. Those audio signals 302 are fed into processing core 100 along video signals from one or more of cameras 210a-c. Specifically, audio signals 302 and the video signals are fed into model selection module 124 (here shown as the multimodal noise classification model 126 and contextual data module 128), where, if necessary, noise signals are separated from speech signals using a source separation technique, then the noise signals are passed into a noise classifier model, as will be understood by those ordinarily skilled in the art having the benefit of this disclosure, and the noise signals identified. Furthermore, in the same module, the video signal may be passed through a computer vision model for video scene understanding to determine which noise sources are currently in act. Then, predictions from these two and/or other approaches may be combined to more accurately identify the noise sources in the room.

Model selection module 124 determines the noise class of the noise signals continuously over time using both noise classification module 126 and contextual data module 128, as described herein. The audio and video signals are analyzed to generate the contextual data informing the system of what is occurring inside the room environment with respect to the noise sources. Similarly, the other contextual data gathered by contextual data module 128 through Calendar app or weather app or user input etc. also informs the system regarding the same. The determined noise classifications 303 are then output continuously over time to cloud platform 122. In this example, cloud platform includes multiple machine learning models, including: Speech Separation Model 1 (w/ two output ports), Speech Separation Model 2 (w/ three output ports), Speech Separation Model N (w/ N output ports), Noise Suppression Model 1 (munching & drinking), Noise Suppression Model 2 (typing & tapping), Noise Suppression Model 3 (door squeak & fan) and Noise Suppression Model N (mouse & pen clicking). Based upon the noise classification transmitted from processing core 100, cloud platform 122 selects the suitable machine learning model(s) and transmits the model to processing core 100. Thereafter, at noise suppression block 304, AVC OS 102 implements the downloaded models to suppress the noise accordingly, thereby only outputting speech at block 306. Note AA and BB refer to the names of the classes that selected models would be able to handle. For example, for X=3, AA would be “Door Squeak” and BB would be “fan” and for X=2, AA would be “Typing” and BB would be “Tapping,” in this example.

Further, using the processing flow of FIGS. 3A and 3B the system can also handle the no-noise case, i.e. whenever the noise classifier determines there is no noise in the room. Here, the processing flow may skip the noise suppression block 304 altogether and save the computational resources. The system can also handle the unknown noise types gracefully using the processing flow: here, when the noise classifier determines the noise class is unknown, at that time the system can record the audio/video feed and store it in the cloud platform 122. Subsequently, the system can then train a new small NS-MX noise suppression model specifically for that noise type using any suitable AI training algorithm and/or dataset, as will be understood by those ordinarily skilled in the art having the benefit of this disclosure.

FIG. 3C is a flow chart of a method for training the machine learning models, according to one illustrative embodiment of the present disclosure. Method 320 begins with block 322, wherein the system captures one or more samples of the noise signal having an unknown class. As described above with reference to FIG. 3B, when the noise classifier determines that a noise class is unknown, the system records the audio and/or video feed and stores the recorded feed in the cloud platform 122. These recorded samples serve as the basis for training a new machine learning model, such as, e.g., a small NS-MX noise suppression model, specifically tailored to address the previously unrecognized noise type.

In this example, at block 324, the system creates a dataset of noise samples that includes one or more augmentations to the captured samples. The augmentations are applied to provide a diversity of noise samples related to the original captured samples, thereby improving the robustness and generalization capability of the trained model. In various embodiments, the augmentations may include, but are not limited to, equalization, pitch shift, spectral masking, tempo changes, time stretching, gain adjustments, additive noise mixing, and/or combinations thereof. By augmenting the captured samples, the system generates a comprehensive training dataset that represents variations of the unknown noise type that the model may encounter in real-world deployment scenarios.

In this example, at block 326, the system iteratively exposes a noise reduction model to the dataset of noise samples and evaluates an output of the noise reduction model. During each iteration, the noise reduction model processes one or more samples from the dataset and produces an output signal. The system then evaluates the output by comparing it to an ideal output, which in the context of noise suppression is typically silence or a clean reference signal with the noise removed. The evaluation generates one or more metrics that quantify the deviation of the model's output from the ideal output. Suitable metrics may include, for example, mean squared error (MSE), signal-to-noise ratio (SNR), perceptual evaluation of speech quality (PESQ), short-time objective intelligibility (STOI), or other loss functions known to those ordinarily skilled in the art having the benefit of this disclosure.

In this example, at block 328, the system determines whether one or more loss targets have been achieved. The loss targets may be defined, for example, as threshold values for the evaluation metrics, convergence criteria based on the rate of change of the loss function, or a maximum number of training iterations. If the loss targets have not yet been achieved, method 320 goes to block 330 where the system adjusts the coefficients of the noise reduction model based upon the metrics calculated from the deviation of the output from the ideal output. This adjustment is performed using a backpropagation phase, wherein gradients of the loss function with respect to the model coefficients are computed and used to update the coefficients in a direction that minimizes the loss. The learning rate and optimization algorithm (e.g., stochastic gradient descent, Adam, RMSprop, or the like) may be selected based on the specific architecture of the noise reduction model and the characteristics of the training dataset. As long as the loss targets are not achieved, the system continues the loop of exposure, evaluation, and adjustment. This iterative process continues until the loss targets are satisfied (“Yes”) at block 328, at which point the model is considered trained.

Thereafter, in this example, the trained noise reduction model (e.g., the NS-MX model) may be stored in the cloud platform 122 and made available for deployment to the room environment, or may be stored locally. As described above, the cloud platform 122 may subsequently deploy the trained NS-MX noise suppression model to a processing core 100 located within the room environment, where it can be applied to optimize audio characteristics by suppressing the previously unknown noise type. In some embodiments, the trained model is also registered in the repository of contextual data 132 so that, upon subsequent detection of the same noise type, the system can automatically select and deploy the trained model without requiring additional training.

FIG. 3C illustrates one example of a training method that may be employed to train a machine-learning model used for activity event correlation and inference in accordance with the present disclosure. However, the training methodology depicted in FIG. 3C is provided for purposes of illustration only and is not intended to limit the scope of the invention. A variety of other training methods, techniques, and architectures may be utilized to train the models described herein, as would be understood by those of ordinary skill in the art having the benefit of this disclosure. Such alternative training methods may include, without limitation, supervised learning, unsupervised learning, semi-supervised learning, self-supervised learning, reinforcement learning, transfer learning, federated learning, active learning, online learning, batch learning, or any combination thereof. The selection of a particular training methodology may depend on factors such as the availability of labeled training data, computational resources, latency requirements, privacy constraints, or the specific characteristics of the deployment environment. Accordingly, the training approach illustrated in FIG. 3C should be understood as one non-limiting embodiment among many possible implementations contemplated by the present disclosure.

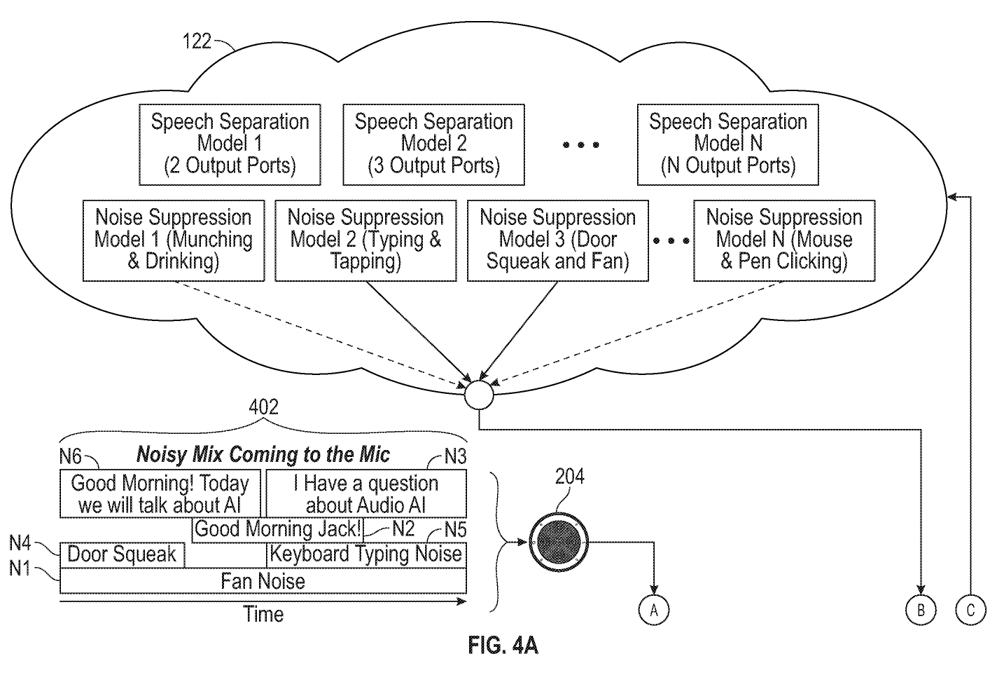

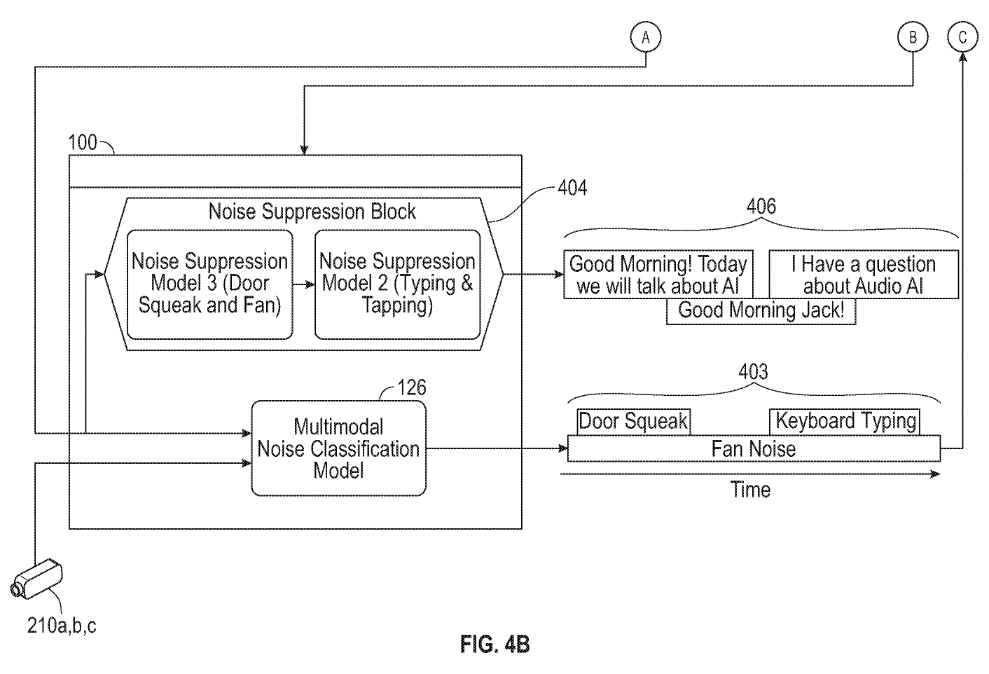

FIGS. 4A and 4B are block diagrams showing a processing flow in the case of multiple overlapping noise sources, according to certain illustrative embodiments of the present disclosure. Here, processing core 100 is being implemented inside room environment 200. processing core 100 is shown along with microphone 204. A noisy mix of overlapping audio signals 402 are captured by microphone 204 including overlapping noise sources N1-N6. Those audio signals 402 are fed into processing core 100 along with video signals from one or more of cameras 210a-c. Specifically, audio signals 402 and the video signals are fed into model selection module 124 (here shown as the multimodal noise classification model 126 and contextual data module 128), where, if necessary, noise signals are separated from speech signals using a source separation technique, then the noise signals are passed into a noise classifier model, as will be understood by those ordinarily skilled in the art having the benefit of this disclosure, those noise signals are identified, and the contextual data is generated and analyzed accordingly. Furthermore, in the same module, the video signal may be passed through a computer vision model for video scene understanding to determine which noise sources are currently in act. Then, the predictions from these two and/or other approaches may be combined to more accurately identify the noise sources in the room.

Based upon the analysis of the contextual data, model selection module 124 then determines the noise class of the noise signals continuously over time using both noise classification module 126 and contextual data module 128, as described herein. The determined overlapping noise classifications 403 are then output continuously over time to cloud platform 122. In this example, cloud platform includes several machine learning models, including: Speech Separation Model 1 (w/ two output ports), Speech Separation Model 2 (w/ three output ports), Speech Separation Model N (w/ N output ports), Noise Suppression Model 1 (munching & drinking), Noise Suppression Model 2 (typing & tapping), Noise Suppression Model 3 (door squeak & fan) and Noise Suppression Model N (mouse & pen clicking). Based upon the noise classification transmitted from processing core 100, cloud platform 122 selects the suitable machine learning model(s) and transmits the model to processing core 100. In this example, two noise suppression models are selected: Noise Suppression Model 3 is tied to Noise Suppression Model 2 (in that order). Thereafter, at noise suppression block 404, AVC OS 102 implements the downloaded models to suppress the noise accordingly, thereby only outputting speech at block 406. Here, the audio signals 402 are first fed through Noise Suppression Model 3, then the output is fed into Noise Suppression Model 2. Input to Model 3 will have speech along with Fan noise, Door Squeak noise and Keyboard Typing noise. The Model 3 will remove Door Squeak and Fan noise, so output of Model 3 will have speech and Keyboard typing noise. Then, this output of Model 3 is passed into Model 2, which will remove Keyboard typing noise. Hence, the output of Model 2 will have just the speech, which will be the final output of the Noise suppression block 404.

In the example of FIGS. 3A, 3B, 4A and 4B, to reinforce the identified noise class prediction, the system utilizes multi-modal noise classification. Here, processing core 100 not only uses the audio feed 402 for noise classification, but also the video feed from cameras 210a,b,c and other contextual data from contextual data module 128. The system passes the video feed from camera(s) 210a,b,c through a scene analysis model (forming part of model selection module 124) to determine if there is some specific noise activity occurring in the room – e.g., whether someone is clicking a pen in the room, eating chips, tapping on the table, noise from people talking in a hallway, etc. – to provide further contextual data. Using this contextual data, the noise class identification would be more accurate thus resulting in more accurate model selection at cloud platform 122. Here, having multiple modalities provides an advantage because there might be some noise classes which are not visible in video, but are audible through the microphone audio signals such as, for example, HVAC and some weather-related noise which might not be clear from audio or video but for which we may get information about from a weather app (through contextual data module 128) or in general if there is some activity outside the camera field of view.

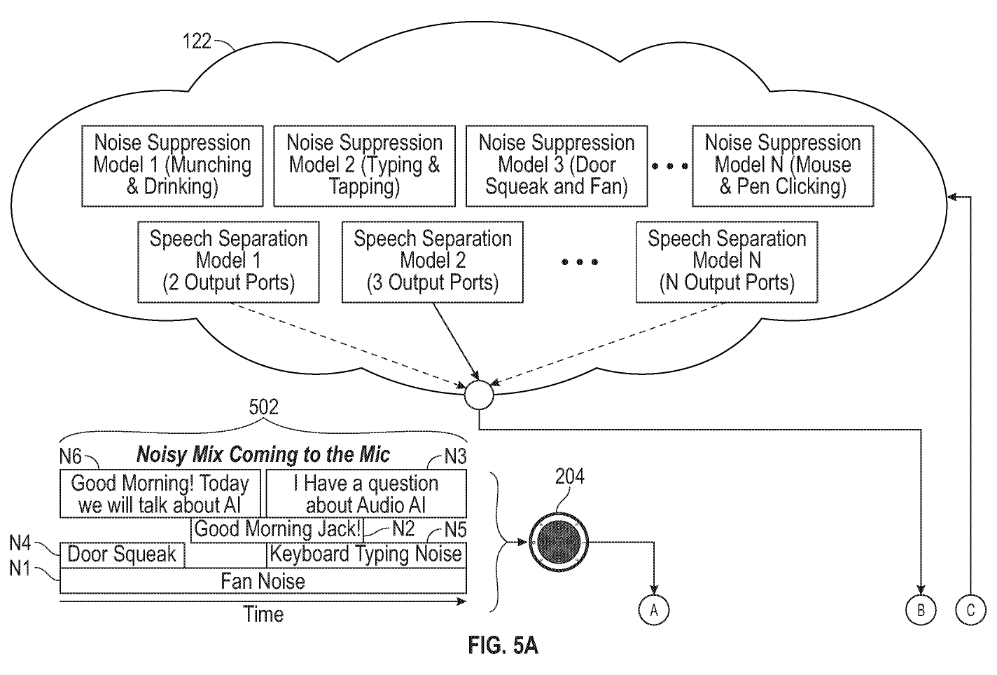

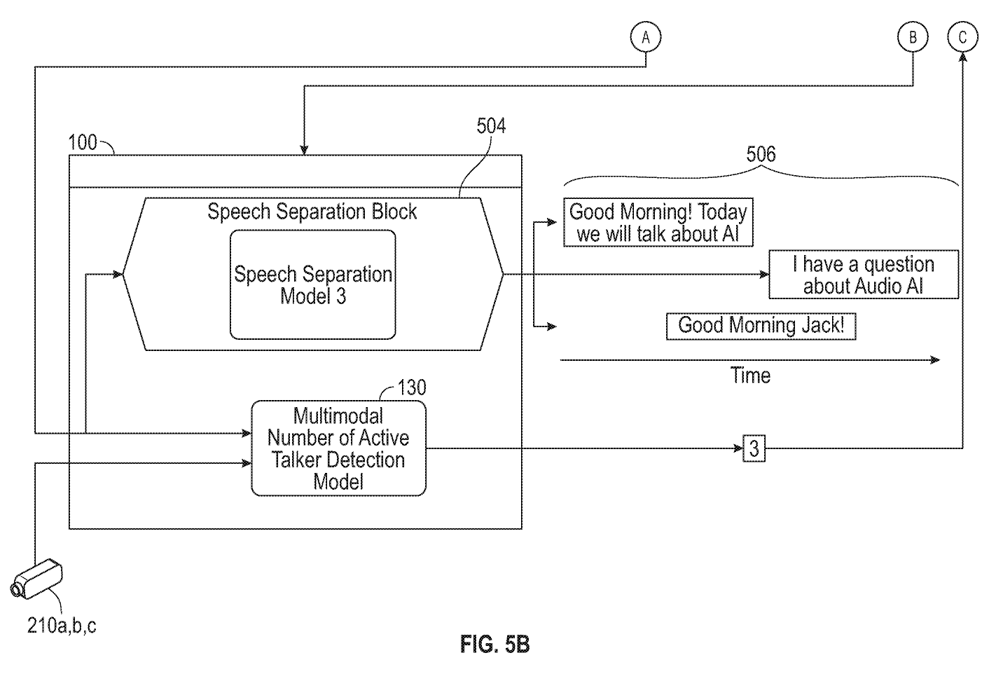

FIGS. 5A and 5B are block diagrams showing a processing flow in the case of speech separation, according to certain illustrative embodiments of the present disclosure. Here, processing core 100 is being implemented inside room environment 200. Processing core 100 is shown along with microphone 204. A noisy mix of overlapping audio signals 502 are captured by microphone 204 including overlapping noise sources N1-N6. Those audio signals 502 are fed into processing core 100 along with video signals from one or more of cameras 210a-c.

Similar to noise classification and noise suppression use case previously described, processing core 100 can also apply the contextual dynamic model selection to speech separation as well. Here, the system monitors the audio feed 502 and video feed received from camera(s) 210a,b,c, continuously to determine the number of participants/active overlapping talkers and then select the speech separation model with appropriate output ports.

With reference to FIGS. 5A and 5B, the audio and video signals are again fed into model selection module 124 as discussed with respect to FIGS. 4A and 4B. However, in this example, model selection module 124 has an active talker detection module 130 to determine the number of active talkers in the audio signals in order to further enhance contextual awareness of the room. There are a variety of talker detection techniques which may be used, as will be understood by those ordinarily skilled in the art having the benefit of this disclosure. In addition, the noise signals may be separated from speech signals using a source separation technique, as also will be understood by those ordinarily skilled in the art having the benefit of this disclosure. Note, as used herein, source separation refers to techniques to separate audio signals coming from different types of sources, e.g., separating noise from music or separating speech from noise, etc.

In this example, three separate talkers are identified by model selection module 124. This identification is achieved using multi-modal number of active talker detection module 130 and contextual data module 128, as described herein. In some embodiments, the identification of the talkers may also be determined using the audio/video or other contextual data (e.g., video identification, calendars of the attendees, weather data, etc.). The determined number of separate talkers are then output continuously over time to cloud platform 122. In this example, cloud platform includes several machine learning models, including: Noise Suppression Model 1 (munching & drinking), Noise Suppression Model 2 (typing & tapping), Noise Suppression Model 3 (door squeak & fan), Noise Suppression Model N (mouse & pen clicking), Speech Separation Model 1 (w/ two output ports), Speech Separation Model 2 (w/ three output ports) and Speech Separation Model N (w/ N output ports).

Based upon the number of talkers transmitted from processing core 100, cloud platform 122 selects the suitable machine learning model(s) and transmits the model to processing core 100. In this example, Speech Separation Model 3 is selected (in this example, it has three output ports to correspond to the identified speakers). Thereafter, at speech separation block 504, AVC OS 102 implements the downloaded model to separate the speaker’s audio, accordingly, thereby outputting three separate speech signals at block 506.

In addition to the models already discussed herein, processing core 100 can also implement other computer vision and audio AI models to determine the context of the room, to thereby dynamically select models from the cloud platform, accordingly. Examples of such scenarios include storing different Audio AI models in the cloud where each of the models work only for a particular RT-60 value range. Then, in the room, the room RT-60 value is identified using an Audio AI model. Then, the appropriate model is selected from the cloud for that particular RT-60 value. A Computer Vision model which can identify the textures/materials in the room may also be utilized to determine the extent of reverberation in the room. In another example, different Audio AI models for different room sizes may be stored in the cloud. Then, using Audio AI or Computer Vision model, the system can determine the size of the room to deploy the appropriate model.

In yet another exemplary use case, the system may utilize different audio AI models for different seating arrangements in the room, e.g., whether it’s a boardroom-like space with a speaker in front and two rows of participants at two different heights, or is it a collaboration space with table in the center and people seating around it. In such cases, the system may utilize Audio AI and/or Computer Vision models to determine the seating arrangement and select the appropriate model for deployment.

Moreover, as can be seen in FIGS. 5A and 5B, even though room environment 200 has five participants (P1-P5), the number of active talkers is only three so, the system’s active talker detection will give an output of three and, hence, the system selects a speech separation model with only three output ports to optimize the computational resources usage. Processing core 100 may further analyze the data (or the data may be processed remotely, e.g., in the cloud or on the AI accelerator 134) and determine at a later time that there are at max two overlapping talkers. In such cases, the system only needs two output ports in the speech separation model to further optimize the resource usage, and so on.

As described herein, any variety of contextual data may be generated and analyzed by contextual data module 128 in order to enable processing core 100 to determine what is occurring inside the room environment. As discussed, the contextual data can be provided, for example, in the form of audio or video signals, direct user input (e.g., foundational room design, location of windows, white board, shades, etc.) in addition to other contextual data known about the location of the room environment (e.g., geographical location, weather, etc.), the attendees (e.g., calendar info), or systems present within the room (e.g., state of HVAC equipment). The geographical or weather data can be provided from third party platforms via other applications 118 or from some remote platforms.

In yet other illustrative embodiments, with reference to FIG. 1, a repository 132 of contextual data for a specific room environment may be generated. In such embodiments, processing circuitry of cloud platform 122 tracks the selected machine learning models deployed for a given room environment over time, and stores this information. Those machine learning models most frequently deployed in a certain room environment may then be automatically downloaded to that room environment when the system is activated. Thereafter, the system monitors the audio and video signals to determine if the deployed models need to be changed or otherwise modified. Although described as being located in cloud platform 122, repository 132 can also be located at other nodes in the network.

In other illustrative embodiments, cloud platform 122 may not house a machine learning model suitable for a given room environment. In such cases, cloud platform 122 may train a suitable machine learning model. This newly trained machine learning model may be generated in real-time and deployed accordingly.

Furthermore, all or part of the processing of the audio/video and other contextual data may be performed at a location remote from the room environment (e.g., cloud platform 122). Alternatively, as described herein, all or part of the processing of the audio/video and other contextual data may be performed locally by processing core 100 and/or by AI accelerator 134.

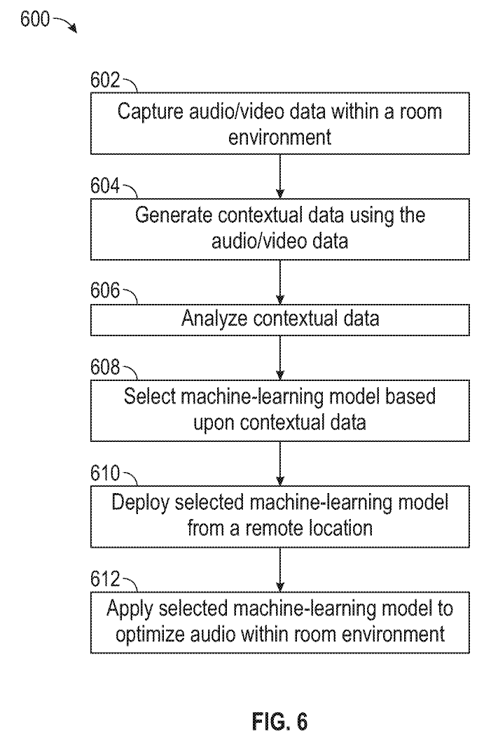

FIG. 6 is a flow chart of a computer-implemented method 600 of the present disclosure. An operating system is implemented on a processing core communicably coupled to one or more peripheral devices. As described herein, the processing core is configured to manage and control functionality of audio, video and control features of the peripheral devices. At block 602, the AVC processing core captures at least one of audio or video data using a microphone or camera, respectively, positioned within the room environment. Note, however, in alternative embodiments the system does not use any audio or video data and instead uses third party data only (e.g., weather data, textual data, geo-position data, calendar data, social medial data, etc.). At block 604, processing core processes at least one of the audio or video data to generate contextual data regarding the room environment. Alternative, here, the system may also generate the contextual data using other sources, e.g., third party apps, user inputs, etc. At block 606, the contextual data is analyzed by the processing core. At block 608, based upon the analysis of the contextual data, the processing core selects one or more machine learning models stored in a location remote from the room environment. The selected machine learning model is then deployed from the remote location to a location within the room environment, at block 610. At block 612, the deployed machine learning models are then applied to optimize audio processing/characteristics of the room environment.

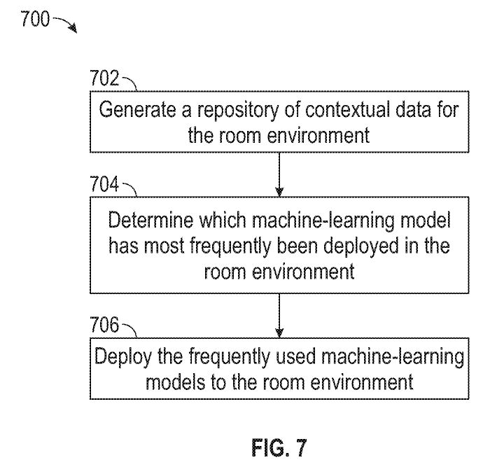

FIG. 7 is a flow chart of a computer-implemented method 700 of the present disclosure. This illustrative method addressing a default case where the system automatically deploys one or more machine learning models to the processing based on the repository 132 of contextual data. At block 702, the processing circuitry of the system generates a repository of contextual data for the room environment over time (e.g., using historic contextual data obtained from the room environment). At block 704, the processing circuitry of the system determines, using the repository of contextual data, which one or more machine learning models have most frequently been deployed inside the room environment. At block 706, processing circuitry of the system then deploys, from a location remote from the room environment (e.g., cloud platform 122), those frequent machine learning models inside the room environment. Note, in certain embodiments, the processing core 100 and processing circuitry in cloud platform 122 may be used separately or in combination to achieve the method 700.

Methods and embodiments described herein further relate to any one or more of the following paragraphs:

1. A computer-implemented method to select a machine learning model for deployment in a room environment, comprising: capturing at least one of audio or video data using a microphone or camera, respectively, positioned within the room environment; processing at least one of the audio or video data to generate contextual data regarding the room environment; analyzing the contextual data; based upon the analysis of the contextual data, selecting one or more machine learning models stored in a location remote from the room environment; deploying the selected one or more machine learning models from the remote location to a location within the room environment; and applying the one or more machine learning models to optimize audio characteristics of the room environment.

2. The computer-implemented method as defined in paragraph 1, wherein the remote location is a cloud platform.

3. The computer-implemented method as defined in paragraphs 1 or 2, wherein the audio or video data is processed at a location remote from the room environment in order to generate the contextual data.

4. The computer-implemented method as defined in any of paragraphs 1-3, wherein selecting the one or more machine learning models comprises: generating one or more machine learning models based upon the analysis of the contextual data; and selecting the generated one or more machine learning models.

5. The computer-implemented method as defined in any of paragraphs 1-4, wherein processing the audio or video data to generate the contextual data further comprises processing third party data.

6. The computer-implemented method as defined in any of paragraphs 1-5, wherein the third party data comprises: calendar data; or weather data related to a geographic location of the room environment.

7. The computer-implemented method as defined in any of paragraphs 1-6, wherein the one or more machine learning models comprise at least one of: a noise suppression model; or a speech separation model.

8. The computer-implemented method as defined in any of paragraphs 1-7, further comprising: generating a repository of contextual data for the room environment over time; determining, using the repository of contextual data, which machine learning models are most frequently deployed inside the room environment; and deploying those frequent machine learning models inside the room environment.

9. A system, comprising: at least one of a microphone or camera located in a room environment; and a processing device communicably coupled to the microphone and camera, the processing device having an audio optimization and control (“AOC”) operating system executable thereon to manage and control functionality of the microphone and camera, the processing device being configured to perform operations comprising: capturing at least one of audio or video data using the microphone or camera, respectively; processing at least one of the audio or video data to generate contextual data regarding the room environment; analyzing the contextual data; based upon the analysis of the contextual data, selecting one or more machine learning models stored in a location remote from the room environment; deploying the selected one or more machine learning models from the remote location to a location within the room environment; and applying the one or more machine learning models to optimize audio characteristics of the room environment.

10. The system as defined in paragraph 9, wherein the remote location is a cloud platform.

11. The system as defined in paragraphs 9 or 10, wherein the audio or video data is processed at a location remote from the room environment in order to generate the contextual data.

12. The system as defined in any of paragraphs 9-11, wherein selecting the one or more machine learning models comprises: generating one or more machine learning models based upon the analysis of the contextual data; and selecting the generated one or more machine learning models.

13. The system as defined in any of paragraphs 9-12, wherein the one or more machine learning models comprise at least one of: a noise suppression model; or a speech separation model.

14. The system as defined in any of paragraphs 9-13, further comprising: generating a repository of contextual data for the room environment over time; determining, using the repository of contextual data, which machine learning models are most frequently deployed inside the room environment; and deploying those frequent machine learning models inside the room environment.

15. A computer-implemented method to select a machine learning model for deployment in a room environment, comprising: generating a repository of contextual data for a room environment; determining, using the repository of contextual data, which one or more machine learning models have most frequently been deployed inside the room environment; and deploying, from a location remote from the room environment, those frequent machine learning models inside the room environment.

16. The computer-implemented method as defined in paragraph 15, wherein the remote location is a cloud platform.

17. The computer-implemented method as defined in paragraphs 15 or 16, wherein the one or more machine learning models comprise at least one of: a noise suppression model; or a speech separation model.

18. A system, comprising: at least one of a microphone or camera located in a room environment; a first processing device communicably coupled to the microphone and camera, the first processing device having an audio optimization and control (“AOC”) operating system executable thereon to manage and control functionality of the microphone and camera; and a second processing device located at a location remote from the first processing device, wherein at least one of the first or second processing devices being configured to perform operations comprising: generating a repository of contextual data for the room environment; determining, using the repository of contextual data, which one or more machine learning models have most frequently been deployed inside the room environment; and deploying, from the remote location, those frequent machine learning models inside the room environment.

19. The system as defined in paragraph 18, wherein the remote location is a cloud platform.

20. The system as defined in paragraphs 18 or 19, wherein the one or more machine learning models comprise at least one of: a noise suppression model; or a speech separation model.

21. A computer-implemented method to select a machine learning model for deployment in an environment, comprising capturing at least one of audio or video data using a microphone or camera, respectively, positioned within the environment; determining, using a noise classifier, that a class of a noise signal present in the audio data is unknown; training one or more machine learning models for the unknown class of the noise signal; after the training, processing at least one of the audio or video data to generate contextual data regarding the environment; analyzing the contextual data; based upon the analysis of the contextual data, selecting the one or more machine learning models; and applying the selected one or more machine learning models to optimize audio characteristics of the environment.

22. The computer-implemented method as defined in paragraph 21, wherein training the one or more machine learning models comprises: capturing one or more samples of the noise signal having the unknown class; creating a dataset of noise samples including one or more augmentations to the captured samples; iteratively exposing a noise reduction model to the dataset of noise samples and evaluating an output of the noise reduction model; adjusting coefficients of the noise reduction model based upon metrics calculated from a deviation of the output from an ideal output; and repeating the exposing, evaluating, and adjusting until one or more loss targets are achieved.

23. The computer-implemented method as defined in paragraphs 21 or 22, wherein the training is conducted in a location remote from the environment.

24. The computer-implemented method as defined in any of paragraphs 21-23, wherein the remote location is a cloud platform.

25. The computer-implemented method as defined in any of paragraphs 21-24, wherein the selected one or more machine learning models are deployed from the remote location to a location within the environment.

26. The computer-implemented method as defined in any of paragraphs 21-25, wherein the one or more machine learning models comprises at least one of: a noise suppression model; or a speech separation model.

27. The computer-implemented method as defined in any of paragraphs 21-26, further comprising: generating a repository of contextual data for the environment over time; determining, using the repository of contextual data, which machine learning models are most frequently deployed inside the environment; and deploying those frequent machine learning models inside the environment.

28. A system, comprising at least one of a microphone or camera located in an environment; and a processing device communicably coupled to the microphone and camera, the processing device having an audio optimization and control (“AOC”) operating system executable thereon to manage and control functionality of the microphone and camera, the processing device being configured to perform operations comprising: capturing at least one of audio or video data using the microphone or camera; determining, using a noise classifier, that a class of a noise signal present in the audio data is unknown; training one or more machine learning models for the unknown class of the noise signal; after the training, processing at least one of the audio or video data to generate contextual data regarding the environment; analyzing the contextual data; based upon the analysis of the contextual data, selecting the one or more machine learning models; and applying the selected one or more machine learning models to optimize audio characteristics of the environment.

29. The system as defined in paragraph 28, wherein training the one or more machine learning models comprises: capturing one or more samples of the noise signal having the unknown class; creating a dataset of noise samples including one or more augmentations to the captured samples; iteratively exposing a noise reduction model to the dataset of noise samples and evaluating an output of the noise reduction model; adjusting coefficients of the noise reduction model based upon metrics calculated from a deviation of the output from an ideal output; and repeating the exposing, evaluating, and adjusting until one or more loss targets are achieved.

30. The system as defined in paragraphs 28 or 29, wherein the training is conducted in a location remote from the environment.

31. The system as defined in any of paragraphs 28-30, wherein the remote location is a cloud platform.

32. The system as defined in any of paragraphs 28-31, wherein the selected one or more machine learning models are deployed from the remote location to a location within the environment.

33. The system as defined in any of paragraphs 28-32, wherein the one or more machine learning models comprises at least one of: a noise suppression model; or a speech separation model.

34. The system as defined in any of paragraphs 28-33, further comprising: generating a repository of contextual data for the environment over time; determining, using the repository of contextual data, which machine learning models are most frequently deployed inside the environment; and deploying those frequent machine learning models inside the environment.

Moreover, the methods described herein may be embodied within a system comprising processing circuitry to implement any of the methods, or a in a non-transitory computer-readable storage medium comprising instructions which, when executed by at least one processor, causes the processor to perform any of the methods described herein.

Although various embodiments and methods have been shown and described, the disclosure is not limited to such embodiments and methods and will be understood to include all modifications and variations as would be apparent to one skilled in the art. Therefore, it should be understood that the disclosure is not intended to be limited to the particular forms disclosed. Rather, the intention is to cover all modifications, equivalents and alternatives falling within the spirit and scope of the disclosure as defined by the appended claims.

What is claimed is:

1. A computer-implemented method to select a machine learning model for deployment in an environment, comprising:
capturing at least one of audio or video data using a microphone or camera, respectively, positioned within the environment;
processing at least one of the audio or video data to generate contextual data regarding the environment;
analyzing the contextual data;
based upon the analysis of the contextual data, selecting one or more machine learning models stored in a location remote from the environment;
deploying the selected one or more machine learning models from the remote location to a location within the environment; and
applying the one or more machine learning models to optimize audio characteristics of the environment.

2. The computer-implemented method as defined in claim 1, wherein the remote location is a cloud platform.

3. The computer-implemented method as defined in claim 1, wherein the audio or video data is processed at a location remote from the environment in order to generate the contextual data.

4. The computer-implemented method as defined in claim 1, wherein selecting the one or more machine learning models comprises:
generating one or more machine learning models based upon the analysis of the contextual data; and
selecting the generated one or more machine learning models.

5. The computer-implemented method as defined in claim 1, wherein processing the audio or video data to generate the contextual data further comprises processing third party data.

6. The computer-implemented method as defined in claim 5, wherein the third party data comprises:
calendar data; or
weather data related to a geographic location of the environment.

7. The computer-implemented method as defined in claim 1, wherein the one or more machine learning models comprise at least one of:
a noise suppression model; or
a speech separation model.

8. The computer-implemented method as defined in claim 1, further comprising:
generating a repository of contextual data for the environment over time;
determining, using the repository of contextual data, which machine learning models are most frequently deployed inside the environment; and
deploying those frequent machine learning models inside the environment.

9. A system, comprising:
at least one of a microphone or camera located in a environment; and
a processing device communicably coupled to the microphone and camera, the processing device having an audio optimization and control (“AOC”) operating system executable thereon to manage and control functionality of the microphone and camera, the processing device being configured to perform operations comprising:
capturing at least one of audio or video data using the microphone or camera, respectively;
processing at least one of the audio or video data to generate contextual data regarding the environment;
analyzing the contextual data;
based upon the analysis of the contextual data, selecting one or more machine learning models stored in a location remote from the environment;
deploying the selected one or more machine learning models from the remote location to a location within the environment; and
applying the one or more machine learning models to optimize audio characteristics of the environment.

10. The system as defined in claim 9, wherein the remote location is a cloud platform.

11. The system as defined in claim 9, wherein the audio or video data is processed at a location remote from the environment in order to generate the contextual data.

12. The system as defined in claim 9, wherein selecting the one or more machine learning models comprises:
generating one or more machine learning models based upon the analysis of the contextual data; and
selecting the generated one or more machine learning models.

13. The system as defined in claim 9, wherein the one or more machine learning models comprise at least one of:
a noise suppression model; or
a speech separation model.

14. The system as defined in claim 9, further comprising:
generating a repository of contextual data for the environment over time;
determining, using the repository of contextual data, which machine learning models are most frequently deployed inside the environment; and
deploying those frequent machine learning models inside the environment.

15. A non-transitory computer-readable storage medium storing instructions that, when executed by a computing system, cause the computing system to perform operations comprising:
capturing at least one of audio or video data using a microphone or camera, respectively, positioned within a environment;
processing at least one of the audio or video data to generate contextual data regarding the environment;
analyzing the contextual data;
based upon the analysis of the contextual data, selecting one or more machine learning models stored in a location remote from the environment;
deploying the selected one or more machine learning models from the remote location to a location within the environment; and
applying the one or more machine learning models to optimize audio characteristics of the environment.

16. The computer-readable storage medium as defined in claim 15, wherein the remote location is a cloud platform.

17. The computer-readable storage medium as defined in claim 15, wherein the audio or video data is processed at a location remote from the environment in order to generate the contextual data.

18. The computer-readable storage medium as defined in claim 15, wherein selecting the one or more machine learning models comprises:
generating one or more machine learning models based upon the analysis of the contextual data; and
selecting the generated one or more machine learning models.

19. The computer-readable storage medium as defined in claim 15, wherein the one or more machine learning models comprise at least one of:
a noise suppression model; or
a speech separation model.

20. The computer-readable storage medium as defined in claim 15, further comprising:
generating a repository of contextual data for the environment over time;
determining, using the repository of contextual data, which machine learning models are most frequently deployed inside the environment; and
deploying those frequent machine learning models inside the environment.

21. A computer-implemented method to select a machine learning model for deployment in a environment, comprising:
generating a repository of contextual data for a environment;
determining, using the repository of contextual data, which one or more machine learning models have most frequently been deployed inside the environment; and
deploying, from a location remote from the environment, those frequent machine learning models inside the environment.

22. The computer-implemented method as defined in claim 21, wherein the remote location is a cloud platform.

23. The computer-implemented method as defined in claim 21, wherein the one or more machine learning models comprise at least one of:
a noise suppression model; or
a speech separation model.

24. A system, comprising:
at least one of a microphone or camera located in a environment;
a first processing device communicably coupled to the microphone and camera, the first processing device having an audio optimization and control (“AOC”) operating system executable thereon to manage and control functionality of the microphone and camera; and a second processing device located at a location remote from the first processing device, wherein at least one of the first or second processing devices being configured to perform operations comprising:
generating a repository of contextual data for the environment;
determining, using the repository of contextual data, which one or more machine learning models have most frequently been deployed inside the environment; and
deploying, from the remote location, those frequent machine learning models inside the environment.

25. The system as defined in claim 24, wherein the remote location is a cloud platform.

26. The system as defined in claim 24, wherein the one or more machine learning models comprise at least one of:
a noise suppression model; or
a speech separation model.

27. A non-transitory computer-readable storage medium storing instructions that, when executed by a computing system, cause the computing system to perform operations comprising:
generating a repository of contextual data for a environment;
determining, using the repository of contextual data, which one or more machine learning models have most frequently been deployed inside the environment; and
deploying, from a location remote from the environment, those frequent machine learning models inside the environment.

28. The computer-readable storage medium as defined in claim 27, wherein the remote location is a cloud platform.

29. The computer-readable storage medium as defined in claim 27, wherein the one or more machine learning models comprise at least one of:
a noise suppression model; or
a speech separation model.

30. A computer-implemented method to select a machine learning model for deployment in an environment, comprising:
capturing at least one of audio or video data using a microphone or camera, respectively, positioned within the environment;
determining, using a noise classifier, that a class of a noise signal present in the audio data is unknown;
training one or more machine learning models for the unknown class of the noise signal;
after the training, processing at least one of the audio or video data to generate contextual data regarding the environment;
analyzing the contextual data;
based upon the analysis of the contextual data, selecting the one or more machine learning models; and
applying the selected one or more machine learning models to optimize audio characteristics of the environment.

31. The computer-implemented method as defined in claim 30, wherein training the one or more machine learning models comprises:
capturing one or more samples of the noise signal having the unknown class;
creating a dataset of noise samples including one or more augmentations to the captured samples;
iteratively exposing a noise reduction model to the dataset of noise samples and evaluating an output of the noise reduction model;
adjusting coefficients of the noise reduction model based upon metrics calculated from a deviation of the output from an ideal output; and
repeating the exposing, evaluating, and adjusting until one or more loss targets are achieved.

32. The computer-implemented method as defined in claim 30, wherein the training is conducted in a location remote from the environment.

33. The computer-implemented method as defined in claim 33 wherein the remote location is a cloud platform.

34. The computer-implemented method as defined in claim 33, wherein the selected one or more machine learning models are deployed from the remote location to a location within the environment.

35. The computer-implemented method as defined in claim 30, wherein the one or more machine learning models comprises at least one of:
a noise suppression model; or
a speech separation model.

36. The computer-implemented method as defined in claim 30, further comprising:
generating a repository of contextual data for the environment over time;
determining, using the repository of contextual data, which machine learning models are most frequently deployed inside the environment; and
deploying those frequent machine learning models inside the environment.

37. A system, comprising:
at least one of a microphone or camera located in an environment; and
a processing device communicably coupled to the microphone and camera, the processing device having an audio optimization and control (“AOC”) operating system executable thereon to manage and control functionality of the microphone and camera, the processing device being configured to perform operations comprising:
capturing at least one of audio or video data using the microphone or camera;
determining, using a noise classifier, that a class of a noise signal present in the audio data is unknown;
training one or more machine learning models for the unknown class of the noise signal;
after the training, processing at least one of the audio or video data to generate contextual data regarding the environment;
analyzing the contextual data;
based upon the analysis of the contextual data, selecting the one or more machine learning models; and
applying the selected one or more machine learning models to optimize audio characteristics of the environment.

38. The system as defined in claim 37, wherein training the one or more machine learning models comprises:
capturing one or more samples of the noise signal having the unknown class;
creating a dataset of noise samples including one or more augmentations to the captured samples;
iteratively exposing a noise reduction model to the dataset of noise samples and evaluating an output of the noise reduction model;
adjusting coefficients of the noise reduction model based upon metrics calculated from a deviation of the output from an ideal output; and
repeating the exposing, evaluating, and adjusting until one or more loss targets are achieved.

39. The system as defined in claim 37, wherein the training is conducted in a location remote from the environment.

40. The system as defined in claim 39, wherein the remote location is a cloud platform.

41. The system as defined in claim 39, wherein the selected one or more machine learning models are deployed from the remote location to a location within the environment.

42. The system as defined in claim 37, wherein the one or more machine learning models comprises at least one of:
a noise suppression model; or
a speech separation model.

43. The system as defined in claim 37, further comprising:
generating a repository of contextual data for the environment over time;
determining, using the repository of contextual data, which machine learning models are most frequently deployed inside the environment; and
deploying those frequent machine learning models inside the environment.

44. A non-transitory computer-readable storage medium storing instructions that, when executed by a computing system, cause the computing system to perform operations comprising:
capturing at least one of audio or video data using a microphone or camera, respectively, positioned within an environment;
determining, using a noise classifier, that a class of a noise signal present in the audio data is unknown;
training one or more machine learning models for the unknown class of the noise signal;
after the training, processing at least one of the audio or video data to generate contextual data regarding the environment;
analyzing the contextual data;
based upon the analysis of the contextual data, selecting the one or more machine learning models; and
applying the selected one or more machine learning models to optimize audio characteristics of the environment.

45. The computer-readable storage medium as defined in claim 44, wherein training the one or more machine learning models comprises:
capturing one or more samples of the noise signal having the unknown class;
creating a dataset of noise samples including one or more augmentations to the captured samples;
iteratively exposing a noise reduction model to the dataset of noise samples and evaluating an output of the noise reduction model;
adjusting coefficients of the noise reduction model based upon metrics calculated from a deviation of the output from an ideal output; and
repeating the exposing, evaluating, and adjusting until one or more loss targets are achieved.

46. The computer-readable storage medium as defined in claim 44, wherein the training is conducted in a location remote from the environment.

47. The computer-readable storage medium as defined in claim 46, wherein the remote location is a cloud platform.

48. The computer-readable storage medium as defined in claim 46, wherein the selected one or more machine learning models are deployed from the remote location to a location within the environment.

49. The computer-readable storage medium as defined in claim 44, wherein the one or more machine learning models comprises at least one of:
a noise suppression model; or
a speech separation model.

50. The computer-readable storage medium as defined in claim 44, further comprising: generating a repository of contextual data for the environment over time;
determining, using the repository of contextual data, which machine learning models are most frequently deployed inside the environment; and
deploying those frequent machine learning models inside the environment.
